(19) United States
(12) Patent Application Publication
(10) Pub. No.: US 2016/0380247 A1
(43) Pub. Date: Dec. 29, 2016

(54) Battery Packs Having Single Stacks of Battery Cells

(71) Applicant: Iontensity, LLC, Livermore, CA (US)

(72) Inventors: Marc Juzkow, Livermore, CA (US); Forest H. Bishop, Livermore, CA (US); Perry Juric, Dublin, CA (US)

(73) Assignee: Iontensity, LLC, Livermore, CA (US)

(21) Appl. No.: 15/192,957

(22) Filed: Jun. 24, 2016

Related U.S. Application Data
(60) Provisional application No. 62/184,355, filed on Jun. 25, 2015.

(51) Int. Cl. H01M 2/10; H01M 2/30

(52) U.S. Cl. CPC H01M 2/1077; H01M 2/105; H01M 2/30

(57) ABSTRACT

Provided are battery packs and methods of fabricating these battery packs. A battery pack includes multiple battery cells stacked together along the center axis of the pack and electrically interconnected with each other by, for example, direct physical contact. The connections may be easily separable by pulling one cell away from another. The stack is enclosed by a pack housing that includes two ends caps and a middle section extending between and supporting the two end caps. One end cap may be removable for accessing to the stack. Furthermore, the end caps may be used to form electrical connections to the battery pack. The middle section of the pack housing may be used for thermal management of the pack. For example, the middle section may include a compartment for a heat transfer material for adding or removing the heat from the battery cells during their operation.

### CROSS-REFERENCE TO RELATED APPLICATIONS

This application claims the benefit under 35 U.S.C. §119(e) of U.S. Provisional Patent Application 62/184,355, entitled: “BATTERY PACKS HAVING SINGLE STACKS OF BATTERY CELLS” filed on Jun. 25, 2015 (Docket No. IONTP001US), which is incorporated herein by reference in its entirety.

### BACKGROUND

Battery packs have many different applications. Some examples include, but are not limited to, automotive, aerospace, boats, motorcycles, power tools, mobile electronics, and power grid balancing. In general, battery packs are used for any applications demanding more capacity and/or power that can be provided by a single electrochemical cell. In battery packs, multiple electrochemical cells are interconnected directly or through various types of battery management systems. Many conventional battery packs have permanent connections (e.g., welding, soldering, and/or crimping) and placement of electrochemical cells, which makes it difficult to repair and even troubleshoot these packs. Usually, battery packs are replaced and may occasionally are sent back to manufacturers for refurbishing. In-field replacement of electrochemical cells in these battery packs is generally not possible. At the same time, applications of many modern battery packs demand prolonged long usage (e.g., many years). Furthermore, these applications may be associated with harsh operating conditions, such as temperature fluctuations, mechanical shocks and vibrations, corrosive environments, and large currents. Overall, battery packs subjected to such applications may experience failure of the electrochemical cells and/or electrical connections among the cells. Ability to repair battery packs and replacement electrochemical cells in these packs is essential for many practical applications.

### SUMMARY

Provided are battery packs having replacement electrochemical cells and methods of fabricating these battery packs. A battery pack includes multiple individual electrochemical cells stacked together along the center axis of the pack. For purposes of this disclosure, the electrochemical cells are referred to as battery cells. Each battery cell represents an enclosed electrochemical unit that has electrolyte isolated (at least ionically) from other battery cells in the same battery pack. For example, each battery cell may have its own case enclosing a set of electrodes having ionic communication through electrolyte.

In some embodiments, the pack includes a battery management system, biasing device, and/or other like devices that are also stacked with the battery cells in the same direction, e.g., along the center axis of the pack. The stack is enclosed by a pack housing that may include two ends caps and a middle section extending between and supporting the two end caps. At least, one end cap may be removable for accessing to the stack disposed within the pack housing. Specifically, when the end cap is removed the cells may be slid out of the middle section through an opening previously closed by the end cap.

Furthermore, the end caps may be used to form electrical connections to the battery pack. For example, each end cap may include an internal conductive surface portion for making an electrical connection to an adjacent battery cell or another component of the battery pack adjacent to the end cap. The same end cap may also include an external conductive surface for making an external electrical connection to the battery pack. These conductive surfaces may be interconnected. Furthermore, each pair of adjacent electrochemical cells within the battery pack may be interconnected by direct physical contact. Some pressure may be provided by one of the components in the stack (e.g., a conductive spring) and/or by one or both end caps.

The middle section of the pack housing may be used for thermal management of the pack. For example, the middle section may include a compartment for a heat transfer material for adding or removing the heat from the battery cells during their operation. For example, the heat transfer material may be circulated through the middle section by an external pump device. In some embodiments, the heat transfer material is a phase change material and is capable of adsorbing and releasing heat during its heat transfer. The phase change temperature may be selected based on desired operating temperature range.

In some embodiments, a battery pack comprises a pack housing and two or more battery cells disposed within the pack housing. The pack housing comprises a middle section, a first end cap coupled to a first end of the middle section, and a second end cap coupled to a second end of the middle section. The two or more battery cells disposed within the pack housing and forming a single stack in a direction between the first end cap and the second end cap. The battery cells are interconnected with each other and both end caps.

In some embodiments, at least one of the first end cap or the second end cap is removably coupled to the middle section. For example, the at least one of the first end cap or the second end cap is threadably coupled to the middle section. In some embodiments, both end caps are removably coupled (e.g., threadably coupled) to the middle section

In some embodiments, the battery pack further comprises a battery management system (BMS). The BMS may be positioned within the single stack with the two or more battery cells. In other words, the BMS and the two or more battery cells are forming the stack and interconnected with each other.

In some embodiments, at least one of the first end cap or the second end cap comprises a connection portion formed from aluminum and coated with one or more of nickel, gold, or platinum. This coating allows forming an electrical connection to the at least one of the first end cap or the second end cap without interference from native aluminum oxide forming on aluminum surfaces. At the same time, aluminum may be used for the bulk of the cap because of its low density, high electrical conductivity, and/or high thermal conductivity. In some embodiments, one such connection portion is disposed on the internal surface of the end cap (facing inside the pack housing). This connection portion may be used for connecting to a battery cell. Another such connection portion may be disposed on the external surface of the end cap and may be used for connecting to the battery pack.

In some embodiments, the middle section comprises a compartment for circulating a heat transfer media. For example, the middle section may include two concentric cylinders with the compartment provided between these cylinders. The compartment may be connected to a temperature control system that is capable of heating or cooling the heat transfer media and, in some embodiments, to circulate the heat transfer media through the compartment. In some embodiments, the compartment may be filled with a phase changing material.

In some embodiments, the battery pack comprises a biasing device. The biasing device may be positioned within the single stack with the two or more battery cells. In some embodiments, the battery pack comprises a fire retardant material filling voids between the two or more battery cells within the pack housing. In some embodiments, the battery pack further comprises a graphite foil disposed between two adjacent ones of the two or more battery cells.

These and other embodiments are described further below with reference to the figures.

### BRIEF DESCRIPTION OF THE DRAWINGS

FIG. 1 is a schematic representation of a battery pack comprising a stack of battery cells enclosed within a pack housing, in accordance with some embodiments.

FIG. 2 is a schematic representation of a battery pack having a pack housing with removable end caps, in accordance with some embodiments.

FIG. 3 is a schematic representation of a battery pack assembly including four battery packs interconnected using electrically conductive connection portion on end caps of the battery packs, in accordance with some embodiments.

FIG. 4 is a schematic representation of a battery pack having a pack housing with a middle section having a compartment for circulating a heat exchanging media, in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

### Battery Pack Examples

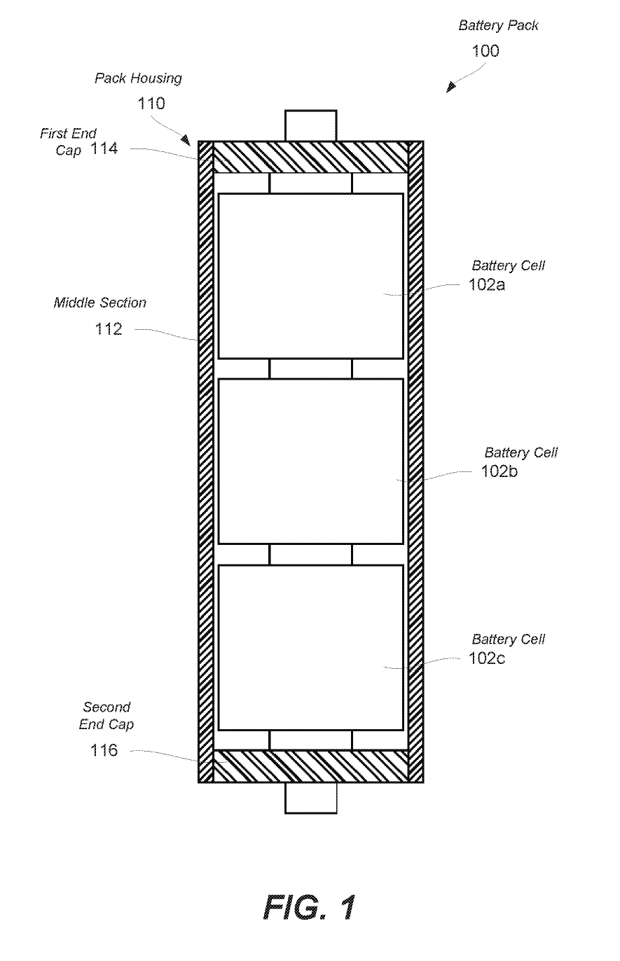

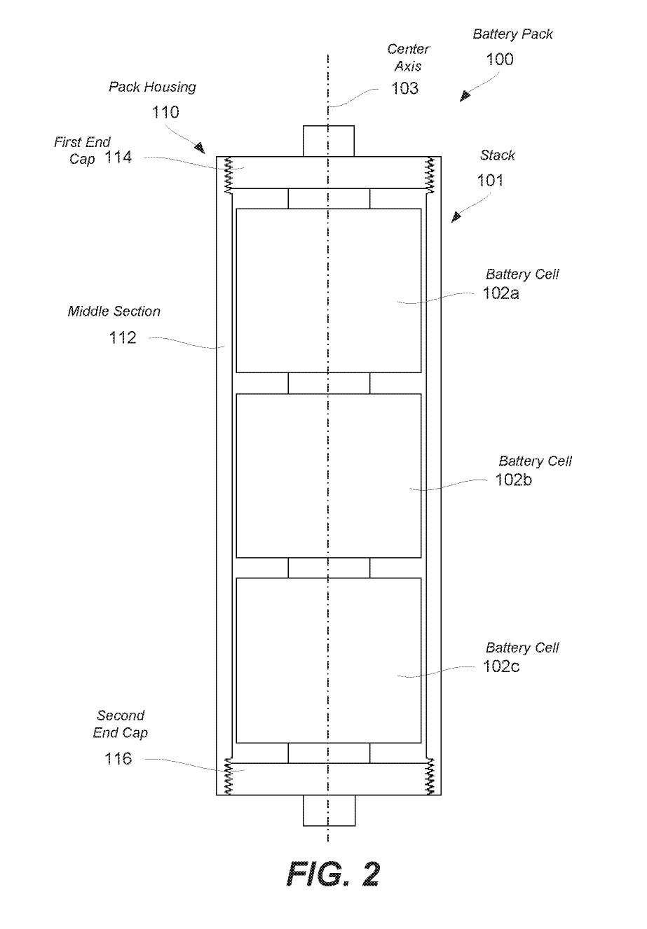

FIGS. 1 and 2 illustrate battery pack 100 including multiple battery cells 102a-102c stacked inside pack housing 110, in accordance with some embodiments. While FIG. 1 illustrates three battery cells 102a-102c, one having ordinary skills in the art would understand that any number of battery cells may be used, e.g., two or more. All cells 102 of battery pack 100 may be arranged into the same stack 101 and may be interconnected, for example, in series. Stack 101 may extend in a direction between first end cap 114 and second end cap 116, which may be operable as electrical terminals of battery pack 100. This direction may coincide with center axis 103 of battery pack 100.

The size of pack housing 110 or, more specifically, the height of pack housing 110 depends on the number of cells stacked inside (as well as on the height of individual cells). For purposes of this disclosure, the height is defined in the direction of center axis 103.

The diameter of battery cells 102a-102c may be greater than their height with an internal cell structure designed to maximize the power density. While such battery cells 102a-102c may have excellent power density on individual level, their design is not suitable for conventional battery packs in which all cells are arranged parallel to each other into a single level planar assembly. Stacking of battery cells 102a-102c as shown in FIGS. 1 and 2 allows to effectively utilize battery cells with small height to diameter ratios. In some embodiments, the height to diameter ratio of battery cells 102a-102c used in battery pack 100 is less than 2 or even less than 1 or even less than 0.5.

For purposes of this document, the term “battery cell” is defines as any electrochemical device including electrochemical double layer devices also known as ultracapacitors and asymmetric ultracapacitors. Some examples of battery cells include but are not limited to 10180, 10280, 10440 (same as AAA cells), 14250, 14500 (same as AA cells), 14650, 15270, 16340, 17340 (same as R123), 17500, 17670, 18350, 18500, 18650, 19670, 25500 (same as C cells), 26650, and 32600 (same D cells), or custom cells. The cells may be cylindrical, prismatic, pouch, or any other type.

Pack housing 110 may have tubular shape and may be designed to snugly fit battery cells 102a-102c. This snug fit ensure mechanical support to battery cells 102a-102c (e.g., to prevent cell from bouncing in pack housing 110 and to maintain electrical connections between battery cells 102a-102c) and/or for heat transfer between battery cells 102a-102c and pack housing 110. In some embodiments, a space in between battery cells 102a-102c and/or between battery cells 102a-102c and component of pack housing 110 (such as first end cap 114, second end cap 116, and/or middle section 112) is filled with a heat transfer media to enhance the heat transfer between battery cells 102a-102c and pack housing 110.

In some embodiments, pack housing 110 may provide mechanical support to battery cells 102a-102c and accommodate (e.g., reduce) volumetric changes (if any) of battery cells 102a-102c. Furthermore, the snug fit may be used for heat transfer between battery cells 102a-102c and pack housing 110, which may be important for battery cells with limited temperature operating range, such as lithium ion cells. For purposes of this description, the snug fit is defined as an average distance between pack housing 110 and battery cells 102a-102c being less than 5% or even less than 1% in the direction perpendicular to the stacking direction.

Pack housing 110 may include middle section 112 and two end caps, such as first end cap 114 and second end cap 116. Middle section 112 may be made from polymer or metal. For example, middle section may be formed from a noncombustible polymer. Middle section 112 may be formed from electrical insulating material. At least portion of first end cap 114 and second end cap 116 may be electrically conductive as further described below.

First end cap 114 and second end cap 116 may be clamped, threaded, crimped, welded, glued or otherwise attached to the ends of middle section 112. In some embodiments, first end cap 114 and/or second end cap 116 may be removably attached to the ends of middle section 112 as, for example, shown in FIG. 2. Specifically, only one of first end cap 114 and second end cap 116 may be removably attached to middle section 112, while the other end cap may be permanently attached using, for example, welding. Alternatively, both first end cap 114 and second end cap 116 may be removably attached to middle section 112. For example, first end cap 114 and second end cap 116 may be threaded to the ends of middle section 112 as, for example, shown in FIG. 2. The removable attachment allows making changes (e.g., replacing one or more of battery cells 102a-102c) after initial assembly of battery pack assembly 110. In some embodiments, a component of battery 100 disposed inside pack housing 110 and most proximate to the removable end cap is a battery management system (BMS). Specifically, the battery management system (BMS) may be positioned between battery cells 102a-102c and the removable end cap. In general, any component of stack 101 that may need more access than other components may be positioned proximate to the removable end cap.

In some embodiments, first end cap 114 and second end cap 116 may be made from conductive materials (e.g., aluminum, copper, steel) and may be operable as battery pack terminals of battery pack 100. In other words, external electrical connections may be formed directly to first end cap 114 and second end cap 116. In this example, first end cap 114 and second end cap 116 may have different polarities. When the bulk of first end cap 114 and second end cap 116 is formed from a conductive material, the electrical insulation between first end cap 114 and second end cap 116 may be provided by middle section 112.

For example, when battery cells 102a-102c are lithium-ion cells using spinel lithium manganese oxide (LMO) and lithium titanium oxide (LTO-Li₄Ti₅O₁₂) electrodes, the battery cell terminals may be made from aluminum. In this case, first end cap 114 and second end cap 116 may be also made from aluminum. In general, any material that is light, conductive, and corrosion resistant may be used.

In some embodiments, first end cap 114 and/or second end cap 116 may be made from an insulating structure (e.g., a polymer bulk) with a conductive structure (e.g., a metal terminal) protruding through the insulating structure.

In some embodiments, a conductive portion of first end cap 114 and/or second end cap 116 (e.g., entire end caps and/or terminals of the end caps) may be formed from one conductive materials (e.g., aluminum). This conductive portion may be coated (e.g., electroplated or coated using other techniques) with another conductive material thus providing a lower resistance between the conductive portion and, for example, an external battery pack connection. Examples of suitable coatings include, but not limited to, aluminum, copper, nickel, gold, and platinum. The composition the coating may be different from the composition of the bulk structure, which supports these coatings. Some of these coatings may be applied on a bulk aluminum structure, for example.

In some embodiments, first end cap 114 and second end cap 116 may include connection portion 107 for connecting to other components, such as other battery packs. These connections between connection portions 107 may be purely mechanical (electrically insulating), purely electrical (providing no practical mechanical support), or mechanical-electrical hybrid. and/or electrical. The connection portion may be threaded or configured for other types of attachment. For example, one connection portion 107 of first end cap 114 or second end cap 116 may have a male thread, while the other end cap one may have a female thread used as its connection portion 107. In other words, first end cap 114 of one battery pack may be treated directly to second end cap 116 of another battery pack and so on. This approach allows to interconnect multiple different battery packs in an efficient manner.

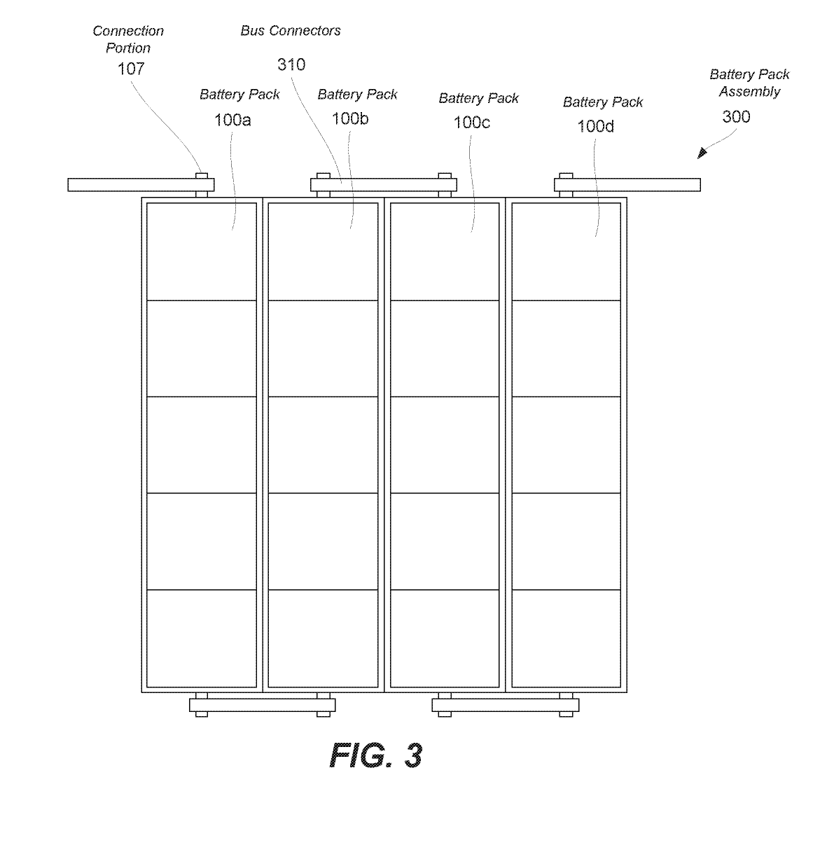

FIG. 3 is a schematic illustration of battery pack assembly 300 including four battery packs 100a-100d interconnected through their connection portions 107. In this example, external bus connectors 310 are attached to connector portions 107 of battery packs 100a-100d thereby interconnecting battery packs 100a-100d. These connections may be used to provide higher voltages, for example. In some embodiments, connection portion 107 may be coated with a low resistance metal or conductive paste.

In some embodiments, battery pack 100 is sealed to prevent gases or liquids that may leak out of the battery cells 102a-102c from being released into the external environment. The seal may be a hermetic seal. For example, if one of battery cells leaks its electrolyte inside pack housing 110, this electrolyte does not escape pack housing 110.

In some embodiments, battery cells 102a-102c can be held in place within battery pack 100 with a spring or a similar biasing device disposed within pack housing 110. The biasing device may provide a constant force applied to contact areas of battery cells 102a-102c as well as first end cap 114 and second end cap 116 thereby maintaining electrical connections. The force may be directed along center axis 103.

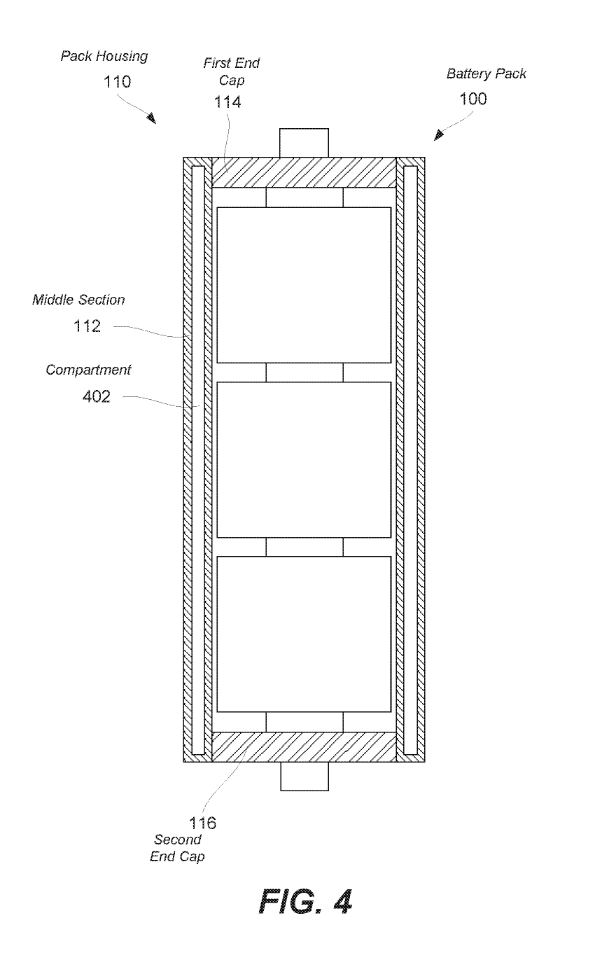

In some embodiments, middle section 112 may have two walls and internal compartment 402 or jacket as shown in FIG. 4. This compartment may be used to provide cooling and/or heating to maintain a constant temperature of battery pack 100 for improved calendar life of battery cells 102a-102c. For example, a heat transfer fluid may be circulated within this compartment 402 using, for example, an external pump. In some embodiments, various thermal transfer features and/or mechanical support features may extend within the compartment. In some embodiments, compartment 402 may be filled with phase change material.

Heating of battery cells 102a-102c using the heat transfer fluid in compartment 402 may be used to assist in ultra-low temperature conditions (e.g., at −20° C. and below) when many types of battery cells 102a-102c are not fully functional. For example, lithium-ion cells do not accept charge or discharge as easily at low temperatures due to increased impedance. If a battery cell is at a low temperature, the application may not operate. For example, in a start-stop automotive application, some vehicles are programmed not to allow recuperation of energy through braking at low temperatures resulting in an overall decreased performance of the system. Heating of battery cells 102a-102c to their normal operation temperature range may reduce the internal impedance of these cells associated with low temperatures and allow for higher rate charge or discharge even though battery pack 100 is still at a low ambient temperature. In some embodiments, compartment 402 can contain gas, liquid or solid. Gas or, more specifically, air (e.g., using Ram air intake or an exterior fan) is a simple (lowest cost) but maybe less effective method to cool or heat the lithium-ion cells in comparison for example to liquids. Liquid heating/cooling is highly efficient. The liquid used can be ethylene glycol similar to radiator fluid. The liquid can be non-flammable to provide additional safety protection in the event of a thermal runaway of a lithium-ion cell. The liquid cooling system can be combined with the radiator system for the engine. A solid can be used inside the tube, in this case a phase change material (PCM) that will absorb heat generated within the battery and melt thereby reducing the battery temperature. When the battery reaches a temperature below that of the melting point of the PCM, the PCM will solidify and release heat energy back into the battery. The returned thermal energy will be lower than extracted from the cells as it will lose heat to the external environment. In some embodiments, middle section 120 may also contain a thermo-electric cooler and/or an electric heater to provide cooling and/or heating

Pack housing 110 or, more specifically, middle section 112 may be also used to provide safety in the event of a thermal runaway of battery cells 102a-102c. For example, pack housing 110 may be designed to contain flames, shrapnel, and other negative effects of uncontrolled battery cells 102a-102c. In some embodiments, pack housing 110 or, more specifically, middle section 112 may be made from a non-flammable material, including metals or non-flammable polymers. One example is a non-flammable polymer under the brand name FireStopper from Tremco. In some embodiments, pack housing 110 may contain a fire retardant material or liquid, e.g., between battery cells 102a-102c and/or between battery cells 102a-102c and first end cap 114 and second end cap 116. For example, a non-conductive fire retardant material or liquid may be used to fill empty spaces within pack housing 110. In some embodiments, pack housing 110 is designed to contain fire, smoke and/or toxic gases in the event of a thermal runaway.

Battery pack 100 may include a vent valve either on an end cap or in the wall of the tube to prevent an explosion of the battery.

In some embodiments, sheets of fire retardant material, graphite foil for example, can be placed between battery cells 102a-102c inside pack housing 110. For instance, if the terminals of battery cells 102a-102c are cylindrical, the fire retardant material may have a donut shape (cylindrical with an outer diameter similar to the internal diameter of middle portion 112 and an inner diameter similar to the outer diameter of the cell terminals). Graphite foil from Graftech, sold under the name of SPREADERSHIELD™ may be used. This type of graphite foil may limit heat flow in the height direction between cells and actually spread the heat within the plane perpendicular to height direction. This approach may be used to ensure that adjacent battery cells 102a-102c do not overheat if one of battery cells 102a-102c overheats.

In some embodiments, battery pack 100 also includes a battery management system (BMS). For example, a BMS unit may have a profile similar to battery cells 102a-102c (but may have a different height). The BMS unit may be positioned between an end cell of battery cells 102a-102c and one of first end cap 114 and second end cap 116. In some embodiments, the BMS unit may be positioned between two of the battery cells 102a-102c. Alternatively, the BMS may be integrated into first end cap 114 and/or second end cap 116 or even into middle portion 112. Functionality of BMS may include voltage balancing, voltage monitoring to provide overcharge and under voltage protection, current monitoring and fusing to provide short circuit protection or overcurrent protection, and temperature monitoring to shut down the system in event of excessive internal and/or external temperature to prevent charging at low temperatures or overheating protection.

In some embodiments, middle portion 112 of pack housing 110 may be substantially transparent (e.g., may be a clear polymer tube) and a cell voltage on each of battery cells 102a-102c may be viewed through middle portion 112. For example, battery cells 102a-102c may be equipped with visual indicators of their voltage. These embodiments simplify troubleshooting. The low performing cell can be easily identified. The replacement may be provided by removable coupling between middle portion 112 and at least one of first end cap 114 and second end cap 116.

In some embodiments, battery pack 100 includes a voltage balancing system, which eliminates the need for external or master BMS.

In some embodiments, wires from the BMS (or the BMS itself) can be placed in a slot of the inner wall of middle portion 112 or the wires can be inside a thin flex circuit that runs along the inside of middle portion 112.

In some embodiments, a cylindrical shape of battery pack 100 compared to, for example, a rectangular battery can allow placement of battery pack 100 in areas of the application where a rectangular battery cannot fit.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

What is claimed is:

1. A battery pack comprising:
a pack housing comprising a middle section, a first end cap removably coupled to a first end of the middle section, and a second end cap coupled to a second end of the middle section,
wherein the first end cap is operable as a first battery pack terminal, and
wherein the second end cap is operable as a second battery pack terminal; and
two or more battery cells disposed within the pack housing, interconnected with each other, and forming a single stack in a direction between the first end cap and the second end cap.

2. The battery pack of claim 1, wherein the middle section is electrically insulating.

3. The battery pack of claim 1, wherein the middle section comprises a non-combustible polymer or a fire-retardant polymer.

4. The battery pack of claim 1, wherein the second end cap is removably coupled to the middle section.

5. The battery pack of claim 1, wherein the first end cap is threadably coupled to the middle section.

6. The battery pack of claim 5, wherein the first end cap is threadably coupled to the middle section.

7. The battery pack of claim 1, further comprising a battery management system (BMS), wherein the BMS is positioned within the single stack with the two or more battery cells and interconnected with the two or more battery cells.

8. The battery pack of claim 1, wherein the two or more battery cells are interconnected in series with each other.

9. The battery pack of claim 1, wherein at least one of the first end cap or the second end cap comprises a connection portion comprising one or more of aluminum, copper, nickel, gold, platinum, or alloys thereof.

10. The battery pack of claim 9, wherein the connection portion is a layer disposed over a bulk portion of the at least one of the first end cap or the second end cap, and wherein composition of the bulk portion is different from composition of the connection portion.

11. The battery pack of claim 9, wherein the connection portion is a part of an external surface of the at least one of the first end cap or the second end cap.

12. The battery pack of claim 1, wherein at least one of the first end cap or the second end cap consists essentially of aluminum or aluminum alloy.

13. The battery pack of claim 1, wherein the middle section comprises a compartment for circulating a heat transfer media.

14. The battery pack of claim 1, wherein the middle section comprises a compartment filled with a phase transfer material.

15. The battery pack of claim 1, wherein a space in between the two or more battery cells and between the two or more battery cells and each of the first end cap and the second end cap is filled with a heat transfer media.

16. The battery pack of claim 1, wherein the two or more battery cells directly interface the middle section of the pack housing.

17. The battery pack of claim 1, further comprising a biasing device, wherein the biasing device is positioned within the single stack with the two or more battery cells.

18. The battery pack of claim 1, further comprising a fire retardant material, wherein the fire retardant material is disposed within voids between the two or more battery cells within the pack housing.

19. The battery pack of claim 1, further comprising a fire retardant material, wherein the fire retardant material is disposed within a compartment of the middle section.

20. The battery pack of claim 1, further comprising a graphite foil disposed between two adjacent ones of the two or more battery cells.
